(19) United States
(12) Patent Application Publication
(10) Pub. No.: US 2018/0280987 A1
(43) Pub. Date: Oct. 4, 2018

(54) Closure System for the Grinding Container of a Crushing Apparatus, and Grinding Container Having Such a Closure System, and Crushing Apparatus Having a Grinding Container

(71) Applicant: NETZSCH-Feinmahltechnik GmbH, Selb (DE)

(72) Inventors: Lars-Peter Weiland, Schönwald (DE); Martin Betzl, Waldsassen (DE); Philipp Rath, Selb (DE)

(21) Appl. No.: 15/562,193

(22) PCT Filed: Feb. 18, 2016
(86) PCT No.: PCT/DE2016/000063

§ 371 Date: Mar. 23, 2018

(30) Foreign Application Priority Data
Apr. 2, 2015 (DE) 10 2015 105 103.6

(51) Int. Cl. B02C 17/18; B02C 17/16

(52) U.S. Cl. CPC B02C 17/1855; B02C 17/161

(57) ABSTRACT

A closure system is disclosed for the grinding container of a crushing apparatus; the grinding container includes at least one closure plug, an adapter unit having a through-opening, in which the closure plug can be inserted, the latter therefore closing the opening and being retained by the adapter unit, and also includes one or more fixing elements, wherein the one or more fixing elements establish a releasable connection between the adapter unit and the grinding container, in order to secure the adapter unit in removable fashion on the grinding container. Also disclosed is a grinding container having a closure system and further discloses a crushing apparatus.

### TECHNICAL FIELD

The present invention relates to a closure system for the grinding container of a crushing apparatus, as well as a grinding container having a closure plug and a crushing apparatus configured as a stirred ball mill.

### BACKGROUND

Crushing apparatuses for solid materials include, as a rule, a grinding container in which grinding material can be contained for a grinding process. The grinding container includes one or more openings through which grinding material required for grinding can be fed and subsequently, after completion of a grinding process, removed. The opening can be closed with the assistance of a closure plug so that the substance to be crushed and the grinding material cannot escape from the grinding container.

It is known that closure plugs of various configuration are used in the grinding container to insulate openings of this kind.

It is a disadvantage, however, that extensive signs of abrasion can emerge on the closure plug, because force generated by the grinding materials in the grinding container and by the substance to be crushed acts directly on the closure plug.

It is the object of the invention to provide a closure system that reduces signs of abrasion on the closure plug and that can be manufactured in a simple manner. An additional object of the present invention is to make available a grinding container and a crushing apparatus having the aforementioned advantages.

These objects are achieved by a closure feature stated in claim 1, by a grinding container and a crushing apparatus according to the invention.

### SUMMARY

The inventive closure system is intended for the grinding container of a crushing apparatus and includes at least one closure plug and an adapter unit having a through-opening into which the closure plug can be inserted. The closure plug can close the opening of the adapter unit and can be retained by the adapter unit. In addition, the closure system comprises one or more fixer elements. By means of the one or more fixer elements, a releasable connection can be established between the adapter unit and the grinding container in order to secure the adapter unit in removable fashion on the grinding container.

It is advantageous that possible signs of abrasion on the closure plug can be substantially reduced in comparison with known closure systems, because, with the system provided here, only the adapter unit must be replaced. The adapter unit can be removed and/or installed quickly and easily as a result of the at least one or more fixer elements. As fixer elements it is advantageous to employ screw-in and/or plug-in connections. Consequently, this also enables replaceability of the various closure systems.

A refinement provides that the opening of the adapter unit comprises a reduced cross-section in certain areas, so that the closure plug is in surface contact with the adapter unit in the area of the reduced cross-section.

The reduced cross-section is configured in such a way that the closure plug can be centered radially relative to the adapter unit. The reduced cross-section can thus be situated in the area toward the grinding container and advantageously can be configured with the assistance of an O-ring. Alternatively, the closure plug can comprise a greater cross-section in the end region toward the container interior.

A useful refinement of the invention foresees that at least one annular gap is configured, at least in certain areas, between the closure plug and the adapter unit.

In this case it is advantageous that the closure plug, without requiring great force, can be fed through the opening of the adapter unit or inserted into the adapter unit. The closure plug is retained and centered only in the area of the reduced cross-section, so that it is necessary to apply increased force only in this section.

In addition, a filter unit can be mechanically coupled to the adapter unit.

The filter unit is distinguished in that the crushed material can be released from the grinding container and simultaneously the grinding materials can be retained by the filter unit.

A refinement of the invention can foresee that the closure plug completely penetrates the opening of the adapter unit and of the grinding container, while the closure plug at its enclosed end tapers conically through the adapter unit.

It is also possible to foresee that a wear plate is positioned between the adapter unit and a container enclosing wall, while the closure plug in this area comprises a smaller diameter relative to its enclosed end through the adapter unit. It is possible to foresee axial insulation of the adapter unit by means of at least one insulating unit.

The insulating unit can be configured in the form of an O-ring and/or the like. The insulating unit can be removed together with the adapter unit in a single motion, so that no additional installation step is required. Likewise, substantially complete insulation of the grinding container can be ensured by means of the insulating unit.

A refinement foresees that the closure system includes at least two retention arms, pivotable relative to one another, which in a certain fixed pivotal position can ensure immobility of the closure plug.

It is advantageous that the closure plug can be held in its clamping position, in addition, by means of fixer elements positioned outside the adapter unit. The at least two retention arms that can pivot relative to one another are easily accessible for the user and simplify operation, particularly in the process of fixing and/or releasing the at least two retention arms that can pivot relative to one another. The at least two retention arms, pivotable relative to one another, can advantageously be configured in the form of a clamp and/or the like.

Also paired with the at least two retention arms, rotatable relative to one another, is at least one securing means, in order to secure the at least retention arms in their fixed pivoting position.

It is advantageous that the closure plug can be additionally secured in its enclosed and centered position. Accidental release, for instance by inadvertent pushing on the closure plug by the user, can be prevented by fixing the closure plug with the assistance of the securing means and/or of the two retention arms. The securing means can be configured as a screw-in connection.

A useful refinement of the invention foresees that the at least one enclosing unit of the at least two retention arms secures the closure plug, at least in certain sections.

The closure plug includes, in portions of its free end, a protrusion, which is advantageously configured in wedge form. It is advantageous that the at least one enclosing unit constitutes a properly fitted counterpiece for this protrusion of the closure plug. The closure plug can thus be fixed in a particular position.

It can also be foreseen that between the adapter unit and the closure plug a groove or indentation is configured, which preferably is ring-shaped, fitting about the peripheral shape of the closure plug.

The groove or indentation can extend preferably between the at least one protrusion of the closure plug and the enclosing unit. The groove or indentation can thus be useful for releasing the closure plug from the adapter unit with the assistance of a lever and/or the like.

A useful refinement of the invention provides that the closure plug comprises a through-opening perpendicular to its longitudinal axis in the area of its free end. A lever element can be inserted through this opening to facilitate lifting out of the plug.

The invention relates, in addition, to a grinding container having a closure system with the features described heretofore. The grinding container has an opening in the grinding container wall. Paired with the opening is an adapter unit for a closure plug that is positioned in releasable fashion by means of one or more fixer elements.

In addition, the invention includes a crushing apparatus having a grinding container of this type. The crushing apparatus can be configured as a ball mill or a stirred ball mill.

### BRIEF DESCRIPTION OF THE DRAWINGS

Embodiments presented below serve to describe the invention and its advantages in greater detail with reference to the appended drawings. Size proportions among the individual elements in the drawings do not always correspond to actual size ratios, since some shapes are simplified and others are shown enlarged in comparison to other elements for a clearer presentation.

FIG. 1A shows a schematic perspective view of an embodiment of an inventive closure system in a front view.

FIG. 1B shows a schematic perspective view of the embodiment of a closure system from FIG. 1A in a rear view.

FIG. 1C shows a cross-section through the embodiment of a closure system from FIGS. 1A and 1B and along the section line A-A from FIG. 1A.

FIG. 2A shows a schematic perspective view of an additional embodiment of a closure system in a front view.

FIG. 2B shows a schematic perspective view of the closure system from FIG. 2A in a rear view.

FIG. 2C shows a cross-section through the embodiment of a closure system from FIGS. 2A and 2B along the section line B-B from FIG. 2A.

FIG. 3A shows a schematic perspective view of an additional embodiment of a closure system in a front view.

FIG. 3B shows a schematic perspective view of the closure system from FIG. 3A in a rear view.

FIG. 3C shows a cross-section of the embodiment of the closure system from FIGS. 3A and 3B along the section line C-C- from FIG. 3A.

Identical reference numbers are used for identical or identically acting elements of the invention. In addition, for the sake of a clear overview, the only reference numbers that are necessary for the description of the respective figure are shown in the individual figures. The illustrated embodiments merely constitute examples of how the invention can be configured and do not represent any conclusive restriction.

### DETAILED DESCRIPTION

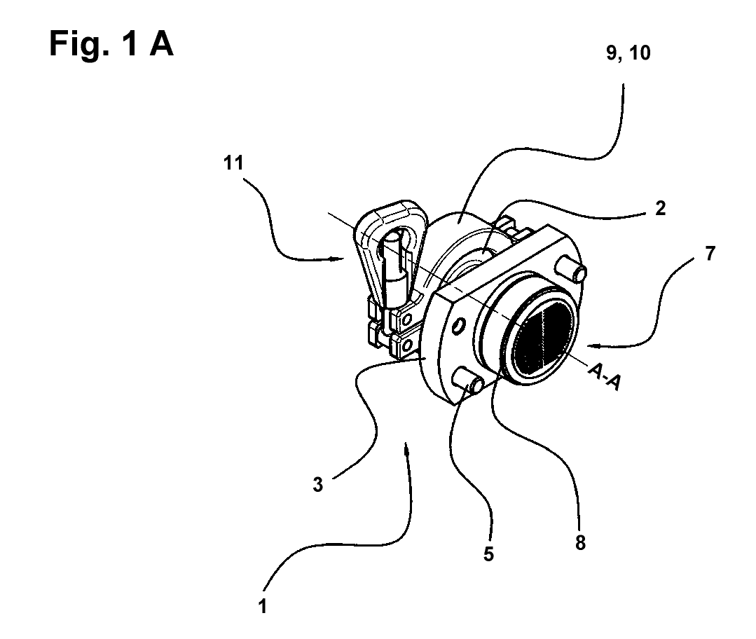

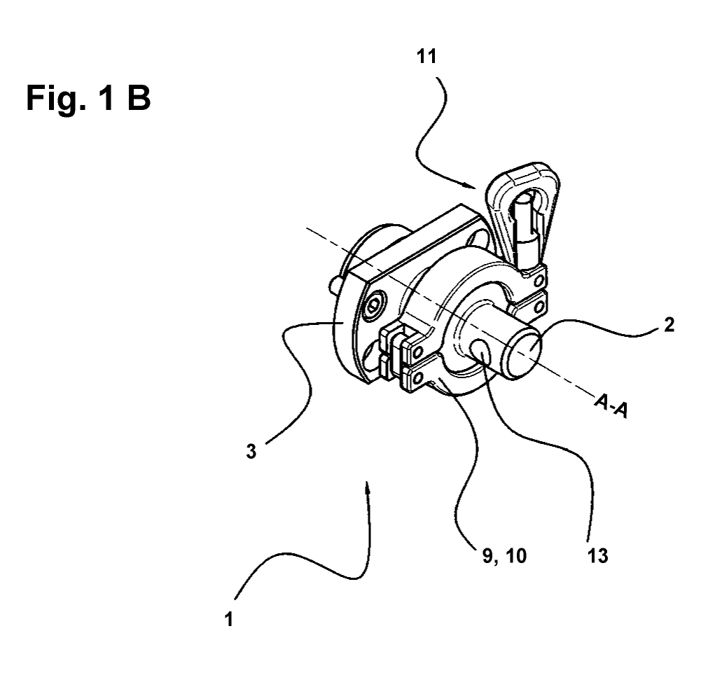

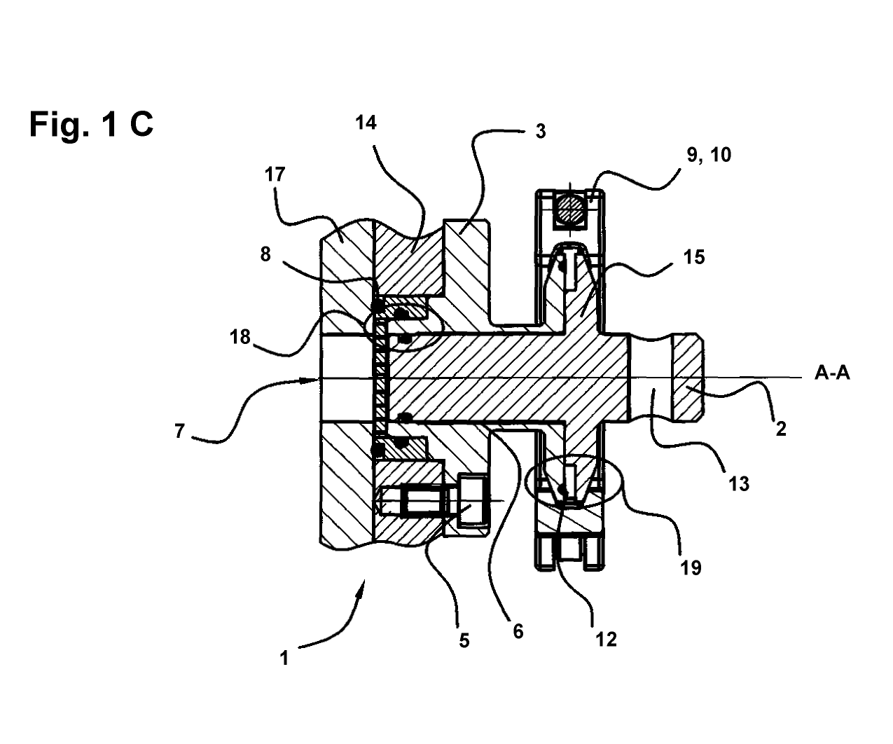

FIG. 1A shows an embodiment of the inventive closure system 1 in a front view. The closure system 1 comprises an adapter unit 3 having one or more fixer elements 5, so that the adapter unit 3 can be fastened releasably to a grinding container, for example a ball mill or stirred ball mill (not illustrated). A filter unit 7 is mechanically coupled to the adapter unit 3. With the assistance of an insulating unit 8, preferably in the shape of an O-ring, the adapter unit 3 is axially or radially insulated relative to a grinding container wall 14. In addition, the closure system 1 includes at least two retention arms 9, 10 that can pivot in relation to one another and in a particular fixed pivot position provide a stop for the closure plug 2 when the closure plug 2 is situated on the grinding container in its enclosed and centered position through the adapter unit 3. Paired with the at least two retention arms 9, 10, which can pivot relative to one another, is a securing means 11.

FIG. 1B shows the embodiment of the closure system 1 from FIG. 1A in a rear view, here with the at least two retention arms 9, 10, which can pivot relative to one another, clearly recognizable. The two retention arms 9, 10, which can pivot relative to one another, fix the closure plugs 2 with the assistance of a securing means 11, which is situated outside the adapter unit 3. The closure plug 2, in addition, comprises on its free end a through-opening 13, which extends perpendicularly to its longitudinal axis. FIG. 1B shows, as a result, the closure plug 2 in its position enclosed by the adapter unit 3.

FIG. 1C shows a cross-section of the closure system 1 from FIG. 1A along a section line A-A. The cross-section depicted here shows the adapter unit 3 positioned on a grinding container wall 14 and simultaneously the closure plug 2 in its enclosed position inside the adapter unit 3. The adapter unit 3 can be releasably paired with one or more fixer elements 5 of the grinding holder wall 14. The closure system 1 is further distinguished by the fact that between the closure plug 2 and the adapter unit 3 an annular gap 6 is configured, at least in certain portions. The closure plug 2 is centered on the reduced cross-section 18 of the opening 4 of the adapter unit 3, said cross-section being configured in certain areas. The closure plug 2 here is in surface contact with the adapter unit 3 in the area of the reduced cross-section 18. The reduced cross-section 18 is situated in the area toward the grinding container. A filter unit 7 is mechanically coupled to the adapter unit 3, preferably at the height or in the area of the reduced cross-section 18, so that the grinding bodies present in the mill are retained.

At the height of the filter unit 7, for axial or radial insulation of the adapter unit 3, an insulating unit 8 is positioned, for example in the shape of an O-ring. The closure plug 2 comprises on its free end a through-opening 13 and at least one protrusion 15. The at least one protrusion 15 is configured in such a way that it is enclosed in at least one enclosure unit 19 of the at least two retention arms 9, 10 that can pivot relative to one another. The closure system 1 is configured in such a way that the closure plug 2 is secured by at least one enclosing unit 19 of the at least two retention arms 9, 10, at least in some areas. Especially noteworthy is the groove or indentation 12, which is configured between the adapter unit 3 and the closure plug 2 and which preferably runs in a ring-shaped course around the periphery of the closure plug 2. The groove or indentation 12 can be useful in order to release the closure plug 2 from the adapter unit 3 with the assistance of a lever and/or the like.

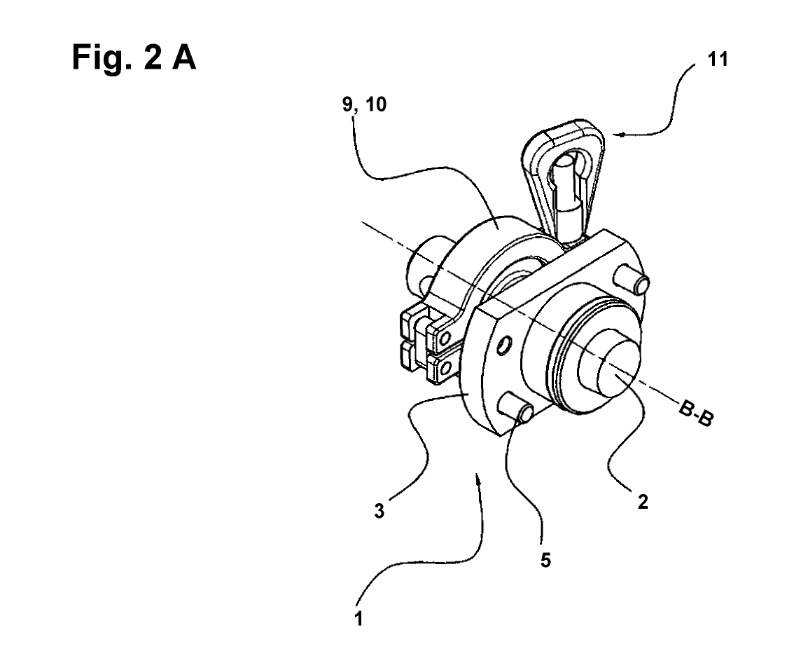

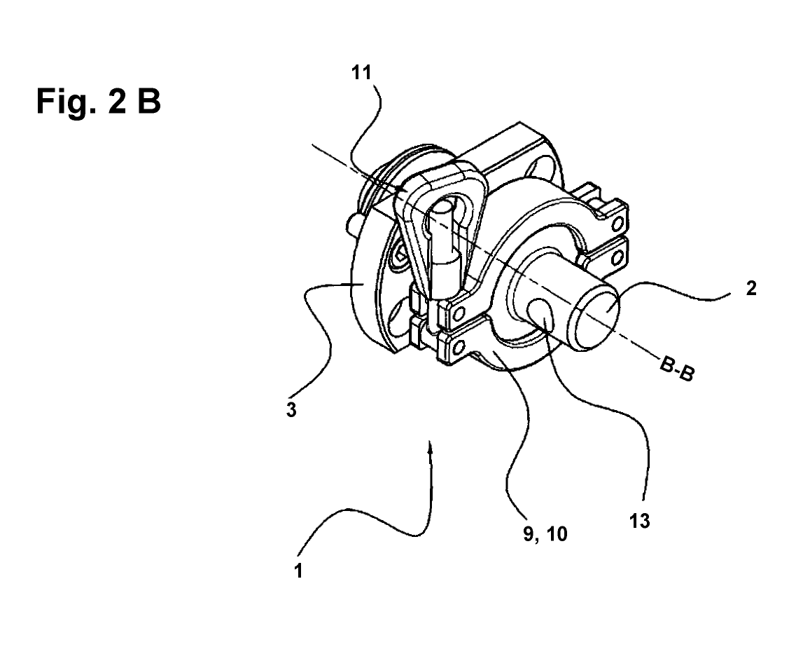

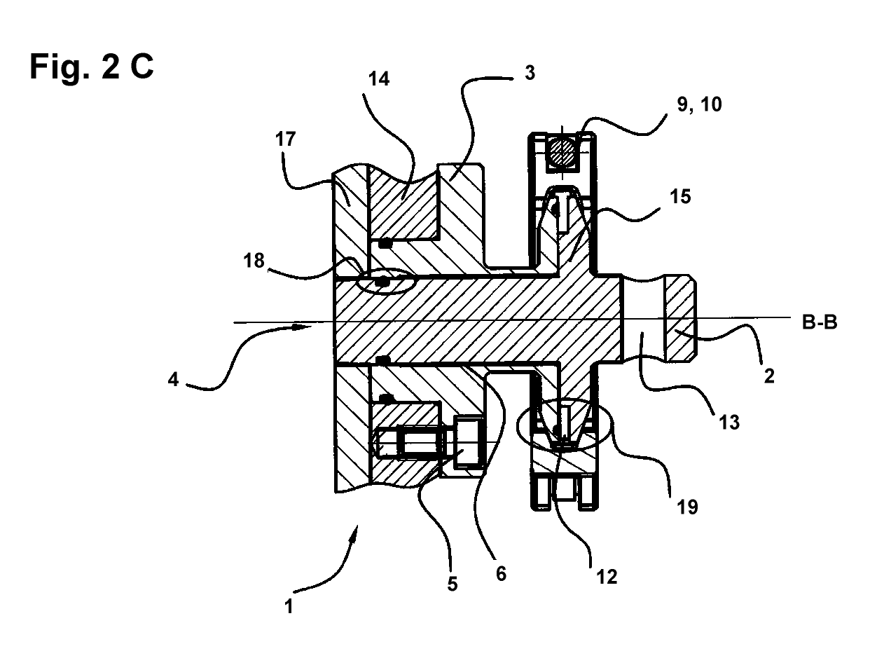

FIG. 2A shows an additional embodiment of the closure system 1 in a front view. The closure system 1 includes, releasably positioned on the grinding container wall 14, an adapter unit 3 with a through-opening 4 (see also the sectioning in FIG. 2C). The adapter unit 3 is fixed on the grinding container wall 14 with one or more fixer elements 5. In addition, the closure system 1, as illustrated in the embodiment in FIG. 1A, includes at least two retention arms 9, 10 that can pivot relative to one another and can be fixed in a firm position with the assistance of a securing means 11. The illustrated embodiment of the closure system 1 is distinguished in that no filter unit 7 is placed ahead of the closure plug 2 and that, instead, the closure plug 2 extends over the entire opening 4 of the adapter unit 3 and the grinding container wall 14.

FIG. 2B shows the embodiment of the closure system 1 from FIG. 2A in a rear view. The closure plug 2 is fixed, as already explained in FIGS. 1A through 1C, by means of two retention arms 9, 10 that can pivot relative to one another and with the assistance of a securing agent 11. In addition, the closure plug 2 retained by the adapter unit 3 comprises on its free end a through-opening 13, perpendicular to its longitudinal axis.

FIG. 2C shows a cross-section of the closure system 1 along a section line B-B from FIG. 2A, such that also in this embodiment an adapter unit 3 is releasably positioned on a grinding container wall 14 by means of one or more fixer elements 5. The adapter unit 3 includes a through-opening 4, in which the closure plug 2 can be inserted so that it closes the opening 4 and is enclosed by the adapter unit 3. The opening 4 of the adapter unit 3 is likewise distinguished in that it has in some places a reduced cross-section 18, so that the closure plug 2 is kept centered and insulating via the adapter unit 3. An annular gap 6 is configured between the closure plug 2 and the adapter unit 3, at least in parts. This embodiment of the closure system 1 of FIGS. 2A through 2C is distinguished in that the closure plug 2 completely penetrates the opening 4 of the adapter unit 3, such that the closure plug 2 at its enclosed end tapers conically and/or the gap between the opening of the grinding holder wall 14 and the conical endpiece of the closure plug 2 expands. In addition, the closure system 1 includes two retention arms 9, 10, which can pivot in relation to one another and which retain the closure plug 2 in a particular position. The at least one protrusion 15 of the closure plug 2 engages into a corresponding recessed unit 19, which is configured by the retention arms 9, 10. Configured between the adapter unit 3 and the closure plug 2 is a groove or indentation 12, which preferably follows the peripheral course of the closure plug 2 in annular shape, in order to facilitate use of, for instance, a lever element for easier removal of the closure plug 2.

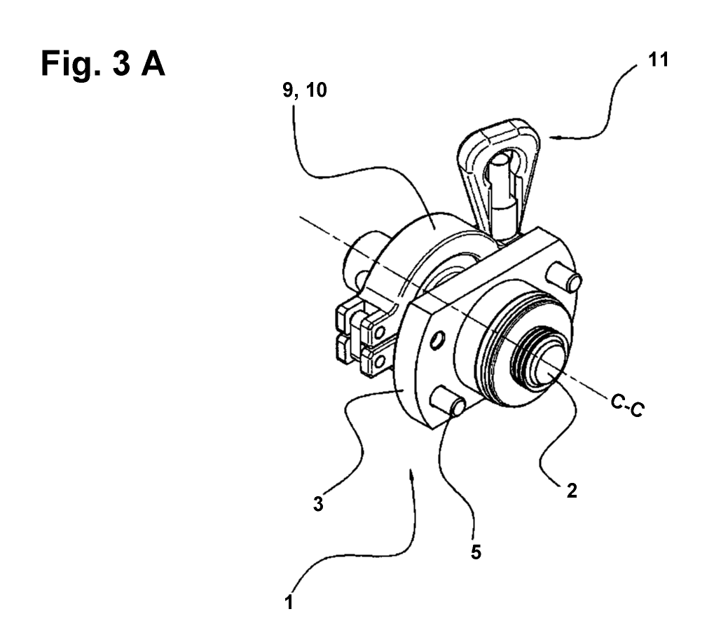

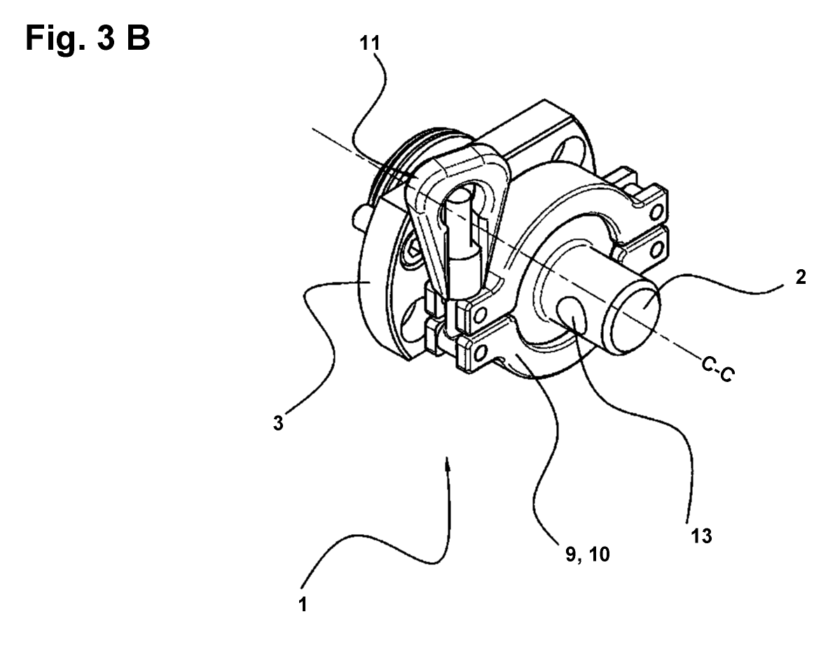

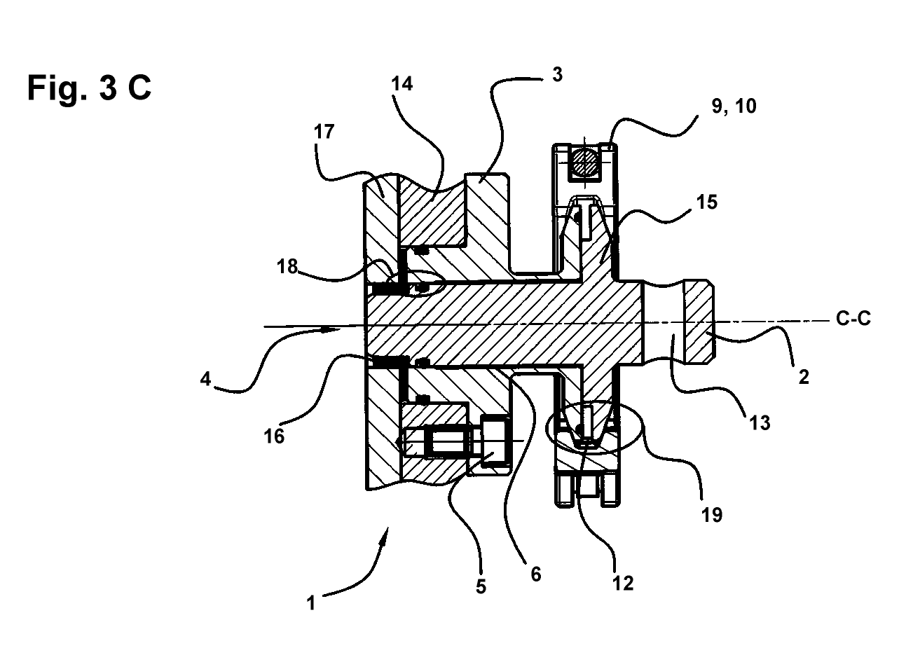

FIG. 3A shows an additional embodiment of the closure system 1 in a front view. The closure system 1 includes an adapter unit 3 having one or more fixer elements 5 and a closure plug 2. In addition, the closure system 1, as in the aforementioned embodiments, includes at least two retention arms 9, 10, which can pivot in relation to one another and which fix the closure plug 2 in a particular position with the assistance of a securing means 11.

FIG. 3B shows the embodiment of the closure system 1 from FIG. 3A in a rear view. The closure plug 2, retained by the adapter unit 3, comprises at its free end, perpendicular to its longitudinal axis, a through-opening 13 and can be secured in a particular fixed pivot position with two retention arms 9, 10, which can pivot in relation to one another, and with the assistance of a securing means 11.

FIG. 3C shows a cross-section of the closure system 1 along a section line C-C from FIG. 3A. The closure system 1 shows an adapter unit 3, which is releasably positioned on a grinding container wall 14 by means of one or more fixer elements 5. The adapter unit 3 includes an opening 4, which can be closed by a closure plug 2 and at least in some areas has a reduced cross-section 18, so that the closure plug 2 is centered. An annular gap 6 is configured, at least in some areas, between the closure plug 2 and the adapter unit 3. The embodiment of the closure system 1 shown in FIGS. 3A through 3C is distinguished in that the closure plug 2 has a lesser diameter at its end enclosed by the adapter unit 3, at least in some areas, and an insulating element 16 is positioned between the adapter unit 3 and a container mantle wall 14. In addition, the closure plug 2 is held in place by the use of at least two retention arms 9, 10, which can pivot in relation to one another. These arms provide at least one enclosing unit 19, so that the at least one protrusion 15 of the closure plug 2 can engage into it, or is enclosed in it with a form-fitting connection. In addition, a groove or indentation 12 is configured by the closure plug 2. The closure plug 2 likewise comprises at its free end a through-opening 13 perpendicular to its longitudinal axis, in order to enable a lever element, for example, to pass through for easier removal of the closure plug 2.

The invention has been described with reference to a preferred embodiment. It is also possible, however, for a person skilled in the art to execute adaptations or modifications of the invention without thereby departing from the protected scope of the claims listed below.

1. A closure system for the grinding container of a crushing apparatus, including:
at least one closure plug;
an adapter unit having a through-opening, into which the closure plug can be inserted so that it closes the opening and is retained by the adapter unit, as well as
one or more fixer elements, wherein the one or more fixer elements establish a releasable connection between the adapter unit and the grinding container in order to secure the adapter unites in removable fashion on the grinding container.

2. The closure system according to claim 1, in which the opening in some areas includes a reduced cross-section, wherein the closure plug is in surface contact with the adapter unit in the area of the reduced cross-section.

3. The closure system according to claim 1, wherein an annular gap is configured, at least in some areas, between the closure plug and the adapter unit.

4. The closure system according to claim 1, wherein a filter unit is mechanically coupled to the adapter unit.

5. The closure system according to claim 1, wherein axial or radial insulation of the adapter unit occurs by means of at least one insulating unit.

6. The closure system according to claim 1, including at least two retention arms that can pivot relative to one another and which, in a defined fixed pivot position, provide a fixing for the closure plug.

7. The closure system according to claim 6, wherein at least one securing means is paired with the at least two retention arms in order to secure the at least two retention arms in the fixed pivot position.

8. The closure system according to claim 1, wherein at least one enclosing unit of the at least two retention arms secures the closure plug , in position, at least in some sections.

9. The closure system according to claim 1, wherein, between the adapter unit and the closure plug, a groove or indentation is configured, which preferably is fed in annular shape about the peripheral course of the closure plug.

10. The closure system according to claim 9, wherein the groove or indentation is fed in annular shape about the peripheral course of the closure plug.

11. The closure system according to claim 1, wherein the closure plug includes a through-opening perpendicular to its longitudinal axis in the area of a free end.

12. A grinding container having a closure system according to claim 1, including an opening in a grinding container wall wherein an adapter unit releasably positioned by means of one or more fixer elements is paired with the opening.

13. A crushing apparatus having a grinding container according to claim 11, wherein the crushing apparatus is configured as a stirred ball mill.

14. The closure system according to claim 2, wherein an annular gap is configured, at least in some areas, between the closure plug and the adapter unit.

15. The closure system according to claim 2, wherein a filter unit is mechanically coupled to the adapter unit.

16. The closure system according to claim 2, wherein axial or radial insulation of the adapter unit occurs by means of at least one insulating unit.

17. The closure system according to claim 2, including at least two retention arms that can pivot relative to one another and which, in a defined fixed pivot position, provide a fixing for the closure plug.

18. The closure system according to claim 2, wherein at least one enclosing unit of the at least two retention arms secures the closure plug in position, at least in some sections.

19. The closure system according to claim 2, wherein, between the adapter unit and the closure plug, a groove or indentation is configured, which preferably is fed in annular shape about the peripheral course of the closure plug.
